(19) United States
(12) Patent Application Publication
(10) Pub. No.: US 2012/0212501 A1
(43) Pub. Date: Aug. 23, 2012

(54) AUTOMATED METHOD FOR CUSTOMIZING THEME COLORS IN A STYLING SYSTEM

(75) Inventors: Philip T. Berkland, Austin, TX (US); Bradley Childs, Austin, TX (US); Jon Ferraiolo, San Jose, CA (US); Jonathan M. Huestis, Apex, NC (US); Javier H. Pedemonte, Austin, TX (US); Adam L. Peller, Newton, MA (US); William D. Reed, Wake Forest, NC (US)

(73) Assignee: INTERNATIONAL BUSINESS MACHINES CORPORATION, Armonk, NY (US)

(21) Appl. No.: 13/031,537

(22) Filed: Feb. 21, 2011

(51) Int. Cl. G09G 5/02

(52) U.S. Cl. 345/593

(57) ABSTRACT

A theme editor system, including: a new color selector to receive a new base color value for a theme; a base color selector to select a current base color value; a color value modifier to calculate a new color value as a function of the current base color value, the new base color value, and a current color value from the theme; and an updater to write a new color value to a style rule, wherein the style rule is stored on a memory device.

### BACKGROUND

The increasing popularity of rich Internet applications (RIAs) has led to the creation of many web toolkits to help designers and developers build RIAs, but only a small number of visual design tools exist, particularly for hypertext markup language (HTML)-based RIAs that leverage HTML, JavaScript and cascading style sheets (CSS). The shortage of visual design tools largely is due to the functional constraints of the underlying technologies and the technical complexity of HTML-based RIA toolkits. As a result, it is often difficult for designers to perform basic RIA customization, particularly global changes to the color scheme within an RIA.

Many of the web toolkits for HTML-based RIAs provide a collection of user interface controls (“widgets”), such as buttons, text entry boxes, menu bars, and calendars, all of which are designed as a compatible set and visually styled by one or more styling themes from which the designer or developer of the RIA may choose. In the realm of HTML, the styling themes are often packaged as a collection of CSS files, such that modifying the color scheme in a given RIA is done by changing the CSS files corresponding to the color scheme. The widget collection and the themes typically require complex and advanced programming techniques to overcome functional constraints of the underlying technologies and to deal with the complex set of behavior aspects of the widgets. The CSS themes are often closely tied to the widget collection in complex and often obscure ways.

To make global changes to the color scheme for an RIA, in most cases, the designer/developer of the RIA would need to learn many of the internal details about the widget collection and theme CSS files, and then manually make many changes to the theme CSS files in order to perform the basic operation of changing the color scheme for an RIA from a particular combination of bluish colors to a particular combination of greenish colors. This may include locating each styling rule that corresponds to each visual element that is part of the RIA. Consequently, modifying the color schemes for RIAs with many different visual elements or highly complex visual interfaces may be time consuming and complex. Additionally, maintaining consistency between the related color elements in the color scheme when changing the color scheme may be difficult when changing the color scheme manually. If multiple RIAs were to be changed to a new color scheme or multiple color schemes, the same painstaking process would have to be repeated for each if done manually.

### SUMMARY

Embodiments of a system are described. In one embodiment, the system is a theme editor system. The theme editor system includes: a new color selector to receive a new base color value for a theme; a base color selector to select a current base color value; a color value modifier to calculate a new color value as a function of the current base color value, the new base color value, and a current color value from the theme; and an updater to write a new color value to a style rule, wherein the style rule is stored on a memory device. Other embodiments of the system are also described.

Embodiments of a computer program product and a method are also described. Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of an RIA customization system.

FIG. 2 depicts a schematic diagram of one embodiment of the theme editor system of FIG. 1.

FIG. 3 depicts a schematic diagram of one embodiment of a widget.

FIG. 4 depicts a flow chart diagram of one embodiment of a method for customizing theme colors in a theme editor system.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments present a method and system for automatically customizing a color scheme for rich Internet applications (RIAs). More specifically, the method and system modify a color scheme of a theme in an RIA Toolkit by accessing cascading style sheet (CSS) style rules in hypertext markup language (HTML) metadata and calculating new color values based on current color values, an old or current base color value, and a new base color value using a color modifier function—which may include a color adjustment factor. Using the same color modifier function, the same base color value, and the same new color value to update the colors in the style rules provides for a consistent color scheme that is based on a selected new base color. It also simplifies the process for developers or designers to change the color scheme by automating the process, rather than requiring the developer/designer to manually change all of the colors.

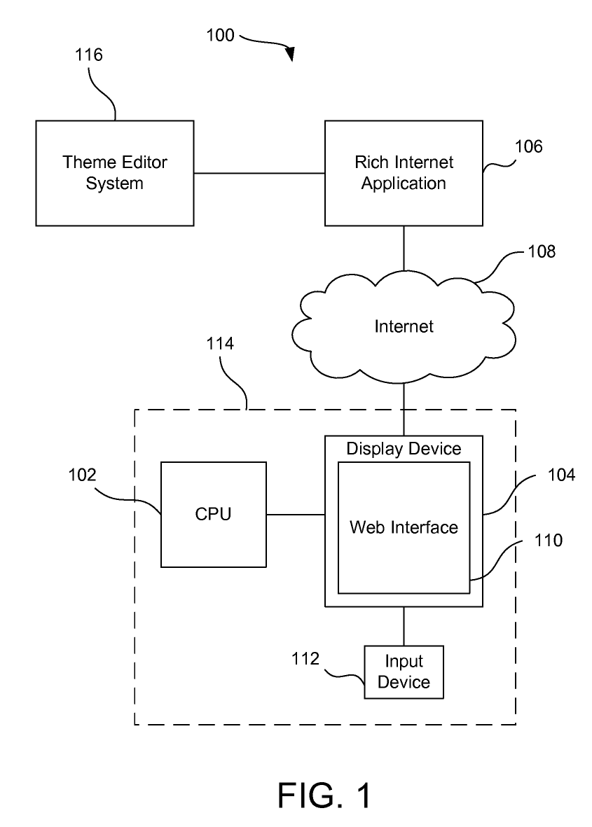

FIG. 1 depicts a schematic diagram of one embodiment of an RIA customization system 100. The RIA customization system 100 includes an end-user device 114, an RIA 106, and a theme editor system 116. In one embodiment, the theme editor system 116 is an Internet-based application that modifies a theme to be used subsequently by an RIA 106. In one embodiment, the theme editor system 116, the RIA 106, and/or the end-user device 114 includes a computer processor 102, such as a CPU, connected to a display device 104. The theme editor system 116, the RIA 106, and/or the end-user device 114 may communicate with one or all of the other devices in the RIA customization system 100 over an Internet connection 108. In another embodiment, one or both of the theme editor system 116 and/or the RIA 106 is stored on a local storage device such that the RIA customization system 100 is able to implement the methods described herein locally. The end-user device 114 may include components or instructions that are also stored locally. The display device 104 may include a web interface 110 to display the RIA 106 or theme editor system 116 on the display device 104 to allow the user or developer to view the RIA 106. The theme editor system 116, the RIA 106, and/or the end-user device 114 may also include an input device 112 in communication with the display device 104 to allow the user to interact with any other components of the RIA customization system 100.

In one embodiment, the theme editor system 116 allows a user to customize colors for a particular theme used in conjunction with an RIA Toolkit. RIA Toolkits provide essential tools and often simplify and speed up the process of creating RIAs 106. RIAs 106 include web applications that have many characteristics of desktop applications, including user interactivity. RIAs 106 may be presented to a user either during development of the RIAs 106 or at an end-user device 114 on a display device 104, such as a monitor, and may be delivered to the display device 104 via a web interface 110 such as a site-specific browser, a browser plug-in, virtual machines, or other interfaces. RIAs 106 may use locally-installed software frameworks to use local resources such as hardware, firmware, operating systems, and software applications belonging to a user's computing device to updated, verify, and/or execute the RIA 106.

Examples of RIA Toolkits that may be used on a computing device include widgets and other applications that may be useful to users. To make the RIAs 106 created using an RIA Toolkit more aesthetically pleasing, the RIAs 106 and/or the RIA Toolkit may be themeable so as to allow a user or developer to modify the look and feel of the widgets found in the RIA Toolkit. In one embodiment, an RIA Toolkit includes one or more themes that provide color schemes for various widgets, subwidgets, and states in the RIA Toolkit. Themes may include other visual aspects, such as images or otherwise. A theme may include specific colors for each part of the RIA 106, such that the overall visual layout displayed to the user may follow a pattern or color scheme of related colors. In HTML, the styling themes may often be packaged as a collection of CSS files.

In HTML, the styling themes may often be packaged as a collection of CSS files. In one embodiment, one development toolkit includes the Dojo Toolkit, which is a JavaScript toolkit that aids the development of RIAs 106. The Dojo Toolkit may include pre-packaged themes for a user to choose for a particular RIA 106. In one example, Dojo Toolkit 1.5 includes a Claro theme, which uses shades of blue for many of the HTML elements included in the RIA 106.

In some conventional embodiments, a developer of an RIA 106 creates or customizes a theme by modifying the corresponding style rules in the CSS metadata. For example, if an RIA 106 is to be specifically designed for an organization that requires a certain color scheme in the RIA 106, the developer may need to change an existing theme for the RIA 106 color by color until all of the colors match the appropriate color scheme. This may require the developer to manually locate each style rule corresponding to a visual HTML element in the color scheme and modify each color value to reflect the new color scheme. This can be very time consuming and is prone to errors.

In addition to the advantages which may be achieved by implementation of the individual components of the theme editor system 116, some embodiments of the theme editor system 116 provide additional advantages over conventional technology. For example, some embodiments of the system 100 and method described herein for automatically creating a theme or modifying an existing theme may reduce RIA 106 development time and may be more accurate than manual modification of the style rules.

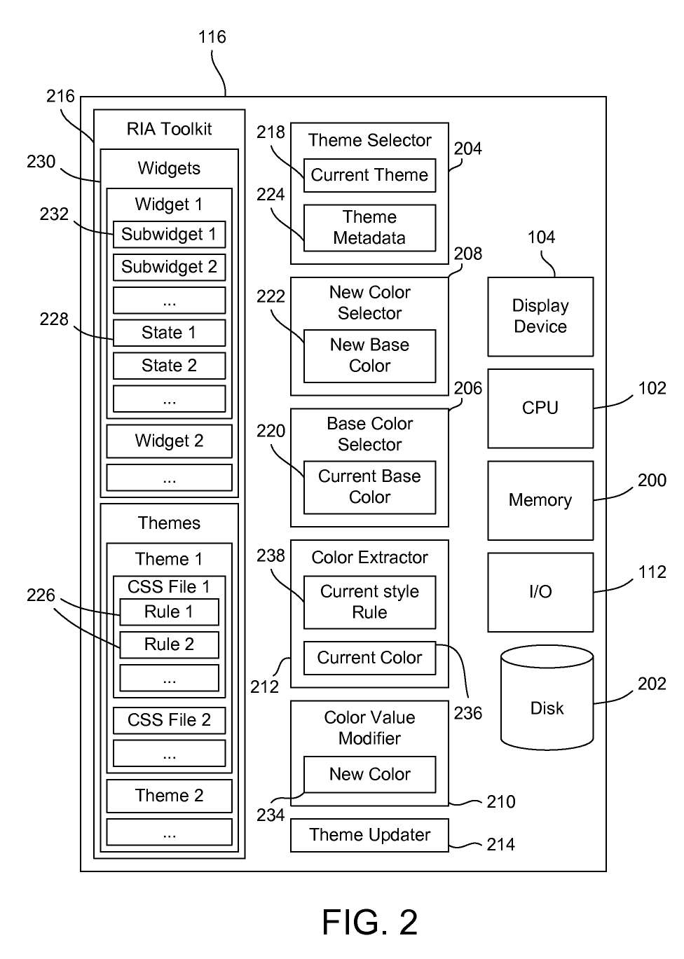

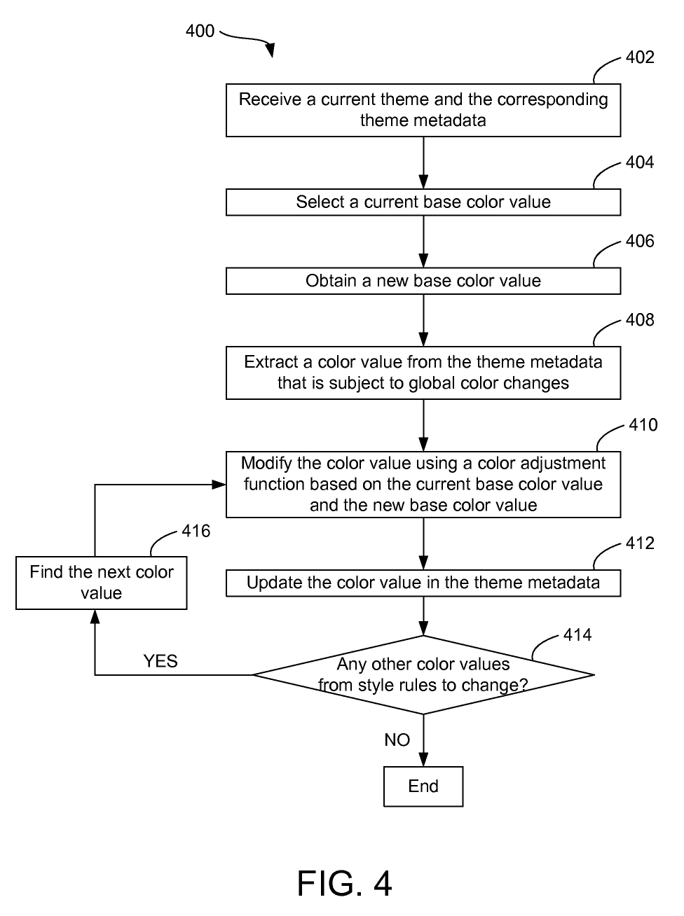

FIG. 2 depicts a schematic diagram of one embodiment of the theme editor system 116 of FIG. 1. The depicted theme editor system 116 includes various components, described in more detail below, that are capable of performing the functions and operations described herein. In one embodiment, at least some of the components of the theme editor system 116 are implemented in a computer system. For example, the functionality of one or more components of the theme editor system 116 may be implemented by computer program instructions stored on a computer memory device 200 and executed by a processing device 102 such as a CPU. The theme editor system 116 may include other components, such as a disk storage drive 202, input/output devices 112, a display device 104, a theme selector 204, a base color selector 206, a new color selector 208, a color extractor 212, a color value modifier 210, a theme updater 214, and an RIA Toolkit 216. Some or all of the components of the theme editor system 116 may be stored on a single computing device or on a network of computing devices. The theme editor system 116 may include more or fewer components than those depicted herein. In some embodiments, the theme editor system 116 may be used to implement the methods described herein as depicted in FIG. 4.

The theme editor system 116 includes a theme selector 204. The theme selector 204 receives an input from an input device 112 indicating a current theme 218 from the user. The current theme 218 may have corresponding theme metadata 224. The current theme 218 is an RIA 106 theme to be edited. In some embodiments, the RIA Toolkit 216 may include multiple themes from which a user may choose. In one embodiment, editing a theme saves an old theme and creates a new theme using the modifications. The current theme 218 or other theme selection may be input into the theme editor system 116 by a developer or at an end-user level.

In one embodiment, the base color selector 206 receives a current base color value 220 that may be associated with the theme 218. The current base color value 220 may be associated with a main color for the current theme 218. Other colors in the theme 218 may be based on the main color, such that the other colors in the theme are related to the base color and to each other. The theme editor system 116 includes a color extractor 208 that extracts a current base color value 220 from the set of style rules 226 within one or more CSS files for the current theme 218. In one embodiment, the current base color value 220 may correspond to a base color defined within the theme metadata 224. In another embodiment, the current base color value 220 may come from a particular color property setting within a particular style rule 226 within the current theme 218. The new color selector 208 may receive a new base color value 222 for the theme. The new base color value 222 may be a color selected by a user on which the theme may be based after the theme editor system 116 implements the modifications.

The theme editor system 116 also has theme metadata 224 that provides a cross-reference between widgets, subwidgets, interactive states, style rules and properties. In one embodiment, the style rules 226 are CSS style rules that at least partially define the visual layout of widgets 230 in the RIA Toolkit 216, including detailed styling rules for the subcomponents of the widgets (and subwidgets 232) and how the widgets 230 appear and behave during different theme states 228 (e.g., normal, active, selected, disabled, hover, and/or others). The content elements for the widgets 230 and subwidgets 232 may be HTML elements, such that the style rules 226 define the visual layout of the HTML elements, including a color of each element, location of each element with respect to other elements, or other visual styling definitions. The set of style rules 226 may be grouped according to widgets 230, subwidgets 232, and states 228 corresponding to the current theme 218 within the metadata 224. In one embodiment, the theme 218 includes a normal theme state, a hover theme state, an active theme state, and a disabled theme state. The style rules 226 corresponding to the normal theme state may define how each element looks in a default state. The style rules 226 corresponding to the hover theme state may define how each element looks when a mouse cursor or other input is positioned over the elements. The style rules 226 corresponding to the active theme state may define how the elements look when the elements are actively selected or otherwise in use. The style rules 226 corresponding to the disabled theme state may define how each element looks when disabled such that the elements are not in use or not usable. Other theme states 228 and style rules 226 may be included in the metadata in addition to or instead of those described herein.

The theme editor system 116 also includes a color value modifier 210 to calculate a new color value 234. The color value modifier 210, according to some embodiments, implements a color modification algorithm that is a function of the current base color value 220, the new base color value 222, and a current color value 236 that is extracted from a current style rule 238 using the color extractor 212. In one embodiment, the new color value 234 is calculated by converting the current base color value 220 and the new base color value 222 into hue, saturation, and light (HSL) values. When stored in a memory device 200 or selected in a color palette, colors may generally be defined in the red-green-blue (RGB) color space. Because some calculations are more difficult to do in the RGB color space, the color values may be converted into an alternate color space, such as the HSL color space, before calculating the new color value 234. Consequently, the color modification algorithm may compute a difference or other color adjustment factor between the current base color value 220 and the new base color value 222 for each of the hue, saturation, and light values of each color value.

In one embodiment, a color adjustment factor is added to the corresponding current color value 236 to achieve the new color value 234 that is a sum of the corresponding current color value 236 and the color adjustment factor. In some embodiments, a sum of the corresponding current color value 236 and the color adjustment factor may create a value that exceeds some upper or lower limit or other constraint in the system 116. In these embodiments, the modifier 210 may compute a new color value 236 at the color space value limit, rather than the true summed value. In another embodiment, the sum may wrap around a given range of values if the sum exceeds the limit.

The theme editor system 116 also includes a theme updater 214 to modify the style rules 226 to include new color values 234 for each current color value 236 within the current theme 218.

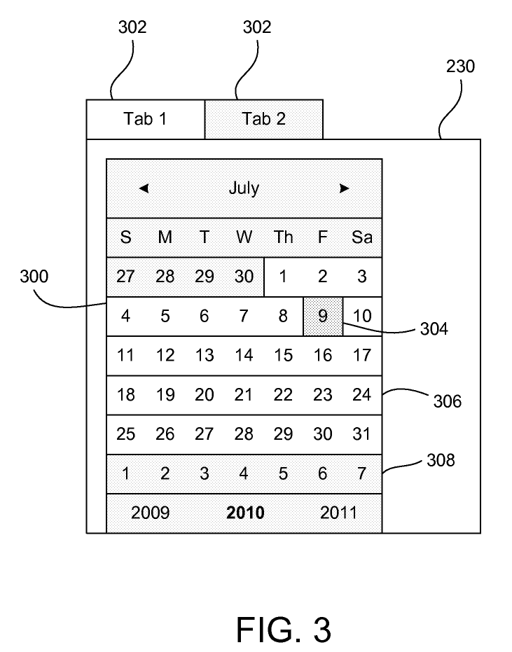

FIG. 3 depicts a schematic diagram of one embodiment of a widget 230 within an RIA Toolkit 216. The widget 230 depicted is a calendar widget that depicts one embodiment of a color scheme in a widget. While the widget 230 shown is a calendar widget, the widget 230 may be any widget or internet application compatible with the system and method described herein.

In one embodiment, the calendar widget displays a calendar 300 typical for web or desktop applications. The calendar 300 may have separate sections showing a current month, each day of the current month, and at least some of the days from a previous month and a subsequent month. The calendar 300 may also have a section displaying the days of the week to match up with the calendar days. The calendar may also include a section for the current, previous, and subsequent years. Each section may be visually or spacially separated so that a user may easily identify the sections. Each section includes at least one or more HTML elements that are stylized by the style rules 226.

The calendar widget may include a theme having a color scheme that also helps a user to quickly identify the separate elements of the calendar widget. The color scheme may include different color values for each section, and yet even different color values for different elements within each section. In one embodiment, each calendar day is a unique HTML element. In another embodiment, the HTML elements are defined according to current day, current month, previous month, subsequent month, year, month, and day of the week. The calendar widget may include more, fewer, or different elements than those described herein. The widget may also include other functionalities. In one embodiment, the RIA 106 includes multiple tabs 302 to switch between one widget and another. Each widget may include a separate color scheme or may share one or more themes.

The theme may identify distinct elements using different color values. For example, in one embodiment, a current day 304 is highlighted with a background color that is different from the background color for each other day 306 in the current month. The calendar days 308 corresponding to the previous and subsequent months may have a background color different from both the current day 304 and other days 306 in the current month. In some embodiments, each unique element may have a different background color from other elements. In other embodiments, some elements may have similar or equal background colors to other elements within the same widget. Each state within the theme may have its own color scheme, such that the user may easily distinguish the different states. Other themes or color schemes may be implemented for RIA 106 than those described herein.

FIG. 4 depicts a flow chart diagram of one embodiment of a method 400 for customizing theme colors in a theme editor system 116. Although the method 400 is described in conjunction with the theme editor system 116 of FIG. 1, embodiments of the method 400 may be implemented with other types of theme editor systems 116.

The theme editor system 116 receives 402 a current theme 218 and the corresponding theme metadata 224, including any style rules 226. The system 116 selects 404 a current base color value 220 for the current theme 218 and also obtains 406 a new base color value 222 to be implemented for the current theme 218. In one embodiment, the current base color value 220 corresponds to a base color for a base or normal state in the theme, where all the colors for the normal state are related default colors for the theme. In another embodiment, the current base color value 220 corresponds to another color in the normal state or in a current state. The new base color value 222 may be selected by a developer or user of the theme editor system 116. The new base color value 222 is used to determine other colors in a new color scheme for the current theme 218 or other theme selection. The theme editor system 116 then retrieves 404 a set of style rules 226 corresponding to the current theme 218 from theme metadata 212. The theme metadata 212 may include CSS style rules 226 for HTML content. The style rules 226 may be stored temporarily on a memory device 200 while the system 116 modifies the style rules 226 to update the RIA 106 with the new color scheme. The style rules 226 may indicate a visual layout and other aesthetics of the RIA 106, including the color value for each element.

After retrieving the style rules 226 and the current base color value 220 and the new base color value 222, the theme editor system 116 extracts 408 a current color value 236 from the style rules 226. The current color value 236 from the theme metadata 224 is subject to global color changes. The colors in the current state are related to a state currently displayed for the RIA Toolkit 216. The system 116 then modifies 410 the current color value 236 using a color value modifier 210 that calculates a new color value 234 as a function of the current base color value 220 the new base color value 222, and the current color value 236. In one embodiment, the color value modifier 210 calculates the new color value 234 after converting the current base color value 220, the new base color value 222, and the current color value 236 to the HSL color space to compute the new base color value 222.

The system 116 then updates 412 the corresponding style rule 226 for the current theme 218. The new color value 234 is written to the style rule 226 in the metadata 224 to update the theme 218 with the new color value 234. In one embodiment, the system 116 checks 414 for additional style rules 226 containing additional color values to be changed, and if the system 116 finds 416 additional color values, the system 116 repeats the modification operation for each additional style rule 218 or color value.

An embodiment of a theme editor system 116 includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to customize theme colors in a styling system 100. The styling system 100 implements a customized color scheme in an RIA Toolkit 216 by accessing CSS style rules 226 referenced by theme metadata 224 and calculating new color values 234 based on existing color values, a current base color value 220 for the theme 218 and a new base color value 222, and then updates any other color values in the style rules 226 for the theme 218.

One embodiment of instructions for a computer program product is shown below. A widget button is shown as a tree of HTML elements:

```
<span class=“dijit dijitReset dijitLeft dijitInline dijitButton” dir=“ltr”
widgetit=“dijit_form_Button_0”>
  <span class=“dijitReset dijitRight dijitInline”>
    <span class=“dijitReset dijitInline dijitButtonNode”>
      <span id=“dijit_form_Button_0” class=“dijitReset dijitStretch
      dijitButtonContents” waistate=“labeledby-
      dijit_form_Button_0_label” wairole=“button” type=“button”
      dojoattachpoint=“titleNode, focusNode”
      dojoattachevent=“ondijitcluser-select: none;”>
        <span class=“dijitReset dijitInline”
        dojoattachpoint=“iconNode”>
          <span class=“dijitReset dijitToggleButtonIconChar”> /
          </span>
        </span>
        <span id=“dijit_form_Button_0_label” class=“dijitReset
        dijitInline dijitButtonText” dojoattachpoint=“containerNode”>
        Button</span>
      </span>
      <input type=“dijit.form.Button” dojoattachpoint=“valueNode”
      style=“display: none ! important;” value=“”>
    </span>
  </span>
</span>
```

The visual customization of a widget for the button shown includes leveraging the CSS styling files found in the styling theme.

The following example shows embodiments of CSS style rules 226 for an HTML widget:

```
    .mytheme .dijitButton .dijitButtonNode,
    .mytheme .dijitDropDownButton .dijitButtonNode,
    .mytheme .dijitComboButton .dijitButtonNode,
    .mytheme .dijitToggleButton .dijitButtonNode, {
      border-width: 1px;
      border-style: solid;
      border-color: #B5BCC7
      padding: 2px 4px 4px 4px;
      background-image: url(“images/button.png”);
      background-position: center top;
      background-repeat: repeat-x;
      background-color: #E4F2FF;
      border-radius: 4px;
      -moz-border-radius: 4px;
      -webkit-border-radius: 4px;
      box-shadow: 0px 1px 1px rgba(0,0,0,0.15);
      -webkit-box-shadow: 0px 1px 1px rgba(0,0,0,0.15);
      -moz-box-shadow: 0px 1px 1px rgba(0,0,0,0.15);
}
```

The system 100 uses metadata files that identify the various style rules 226 in the theme that use a particular color value and groups them within the metadata 224 files. In the example above, the “Normal” state grouping is used as the base color for all the widgets in the theme.

One example of the “Normal” state grouping is shown below:

```
“states”: {
  “Normal”: {
    “selectors”: {
      “.mytheme .dijitCalendar” : [
        “border-color”,
        “background-color”
      ],
      “.mytheme .dijitTabContent”: [
        “border-color”
      ],
      “.mytheme .dijitTabPaneWrapper”: [
        “border-color”
      ],
      “.mytheme .dijitButton .dijitButtonNode”: [
        “background-color”,
        “border-color”
      ],
      “.mytheme .dijitAccordionInnerContainer”: [
        “border-color”
      ],
      “.mytheme .dijitAccordionContainer .dijitAccordianContainer-
      child”: [
        “border-color”
      ],
      “.mytheme .dijitTitlePane”: [
        “border-color”
      ],
      “.mytheme .dijitTitlePaneTitle”: [
        “border-color”
      ],
      “.mytheme .dijitTitlePaneContentOuter”: [
        “border-color”
      ],
      “.mytheme .dijitBorderContainer”: [
        “border-color”
      ],
      “.mytheme .dijitBorderContainer-child”: [
        “border-color”
      ],
    },
    “query”: “div.dijitTabContainerTop-tabs > div”,
    “simulate”: “dijitChecked dijitTabChecked”,
    “defaults”: {
      “cssProperty”: {
        “background-color”: “#D4EBFF”
        “border-color”: “#B5BCC7”
      },
    },
  }
```

An “Active” state grouping is shown below:

```
“Active”: {
  “selectors”: {
    “.mytheme .dijitTabActive .dijitTabInnerDiv” : [
        “background-color”
    ],
    “.mytheme .dijitAccordionInnerContainerActive”: [
        “background-color”,
        “border-color”
    ],
    “.mytheme .dijitSplitterVActive”: [
        “background-color”
    ],
    “.mytheme . dijitSplitterHActive”: [
        “background-color”,
    ],
    “.mytheme . dijitButtonActive .dijitButtonNode”: [
        “border-color”,
        “background-color”
    ],
    “.mytheme .dijitTitlePaneActive”: [
        “border-color”,
        “background-color”
    ],
    “.mytheme .dijitToolbar .dijitButtonActive .dijitButtonNode”: [
        “border-color”,
        “background-color”
    ],
  “defaults”: {
    “cssProperty”: {
        “background-color”: “#8BC4F9”
        “border-color”: “#769DC0”
    },
  },
}
```

When using the method described herein with an authoring tool, a developer may select a new “Normal” or base color to apply to the theme; for example, the developer may select a new “Normal” background-color. The system 100 may retrieve any style rules 226 within the metadata 224 file whose color values were derived from the base color and iterate through the corresponding style rules 226 to update the color values.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. A computer readable storage medium is a specific type of computer-readable or -usable medium. Examples of a computer-readable medium include a semiconductor or solid state memory, magnetic tape, a removable computer diskette, a random access memory (RAM), a read-only memory (ROM), a rigid magnetic disk, and an optical disk. Hardware implementations including computer readable storage media also may or may not include transitory media. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product, comprising:
a computer readable storage device to store a computer readable program, wherein the computer readable program, when executed by a processor within a computer, causes the computer to perform operations for customizing theme colors in a theme editor system, the operations comprising:
receiving a new base color value for a theme;
selecting a current base color value;
calculating a new color value as a function of the current base color value, the new base color value, and a current color value from the theme; and
writing the new color value to a style rule, wherein the style rule is stored on a memory device.

2. The computer program product of claim 1, wherein the computer program product, when executed on the computer, causes the computer to perform additional operations, comprising:
receiving the theme in a theme selection from a user; and
retrieving a set of style rules corresponding to the theme selection from theme metadata.

3. The computer program product of claim 2, wherein the computer program product, when executed on the computer, causes the computer to perform additional operations, comprising:
checking the set of style rules for a theme state; and
modifying each style rule corresponding to the theme state using a color adjustment factor based on the current base color value, the new base color value, and the current color value.

4. The computer program product of claim 3, wherein the color adjustment factor comprises a difference in value for at least one of hue, saturation, or lightness between the current base color value and the new base color value.

5. The computer program product of claim 2, wherein the set of style rules comprises cascaded style sheet (CSS) rules for hypertext markup language (HTML) content.

6. The computer program product of claim 1, wherein the current base color value is selected from a base theme state, wherein the base theme state comprises a set of related default color values.

7. The computer program product of claim 1, wherein the current base color value is selected from a current theme state, wherein the current theme state comprises a set of related current color values.

8. A method for customizing theme colors in a theme editor system, the method comprising:
receiving a new base color value for a theme;
selecting a current base color value;
calculating a new color value as a function of the current base color value, the new base color value, and a current color value from the theme; and
writing the new color value to a style rule, wherein the style rule is stored on a memory device.

9. The method of claim 8, further comprising:
receiving the theme in a theme selection from a user; and
retrieving a set of style rules corresponding to the theme selection from theme metadata.

10. The method of claim 9, further comprising:
checking the set of style rules for a theme state; and
modifying each style rule corresponding to the theme state using a color adjustment factor based on the current base color value, the new base color value, and the current color value.

11. The method of claim 10, wherein the wherein the color adjustment factor comprises a difference in value for at least one of hue, saturation, or lightness between the current base color value and the new base color value.

12. The method of claim 9, wherein the set of style rules comprises cascaded style sheet (CSS) rules for hypertext markup language (HTML) content.

13. The method of claim 8, wherein the current base color value is selected from a base theme state, wherein the base theme state comprises a set of related default color values.

14. The method of claim 8, wherein the current base color value is selected from a current theme state, wherein the current theme state comprises a set of related current color values.

15. A theme editor system, comprising:
a new color selector to receive a new base color value for a theme;
a base color selector to select a current base color value;
a color value modifier to calculate a new color value as a function of the current base color value, the new base color value, and a current color value from the theme; and
an updater to write the new color value to a style rule, wherein the style rule is stored on a memory device.

16. The system of claim 15, further comprising a theme selector configured to receive the theme in a theme selection from a user, wherein a set of style rules corresponding to the theme is located in theme metadata.

17. The system of claim 16, wherein the updater is further configured to:
check the set of style rules for a theme state; and
update each style rule corresponding to the theme state using a color adjustment factor based on the current base color value, the new base color value, and the current color value.

18. The system of claim 17, wherein the color adjustment factor comprises a difference in value for at least one of hue, saturation, or lightness between the current base color value and the new base color value.

19. The system of claim 15, wherein the current base color value is selected from a base theme state, wherein the base theme state comprises a set of related default color values.

20. The system of claim 15, wherein the current base color value is selected from a current theme state, wherein the current theme state comprises a set of related current color values.
